(19) United States
(12) Patent Application Publication
(10) Pub. No.: US 2024/0354202 A1
(43) Pub. Date: Oct. 24, 2024

(54) SYSTEM AND METHOD FOR AUTOMATIC SELECTION OF NETWORK ATTACHED STORAGE CLUSTER NODES FOR DATA PROTECTION

(71) Applicant: Dell Products L.P., Round Rock, TX (US)

(72) Inventors: Upanshu Singhal, Bangalore (IN); Ashish Kumar, Bangalore (IN); Nitin Kumar, Ranchi (IN); Lalita Dabburi, Bangalore (IN)

(21) Appl. No.: 18/302,103

(22) Filed: Apr. 18, 2023

(51) Int. Cl. G06F 11/14; H04L 67/1097

(52) U.S. Cl. CPC G06F 11/1464; H04L 67/1097; G06F 2201/84

(57) ABSTRACT

A system includes a network attached storage (NAS) system, and a backup manager, programmed to: obtain a backup request for a backup of a set of NAS assets, in response to the backup request: obtain a list of network interfaces associated with a first NAS asset of the NAS assets and a second list of network interfaces associated with a second NAS asset of the set of NAS assets, wherein the list of network interfaces and the second list of network interfaces is obtained based on a network interface discovery applied to the NAS system, perform an interface analysis for the first NAS asset to select, from the list of network interfaces, a first subset of network interfaces, and select a backup agent for a first backup operation based on the first subset of network interfaces, and initiate the first backup operation based on the backup agent.

### BACKGROUND

Computing devices in a system may include any number of internal components such as processors, memory, and persistent storage. The computing devices may execute applications (e.g., software). The data generated by the applications may be backed up to a secondary system.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a diagram of a network attached storage (NAS) system in accordance with one or more embodiments of the invention.

FIG. 3 shows a relationship diagram in accordance with one or more embodiments of the invention.

FIG. 4A shows a flowchart for performing an interface discovery in accordance with one or more embodiments of the invention.

FIG. 4B shows a flowchart for selecting communication interfaces for a backup operation in accordance with one or more embodiments of the invention.

FIGS. 5A-5B shows an example in accordance with one or more embodiments of the invention.

FIG. 6 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to a method and system for distribution of backup or recovery streams to multiple compute nodes in parallel to balance the workload equally or in an optimal manner to maximize the usage of available capacity on all compute nodes. A capacity of a compute node may be determined based on a number of parallel write streams to a target storage, a number of parallel read streams from target storage, and a number of CPUs on a compute node.

Embodiments disclosed herein provide methods and systems for automatically discovering and selecting the highest rated interface for backup and recovery. Embodiments provide a system that includes a backup manager that discovers all cluster nodes from a network attached storage (NAS) array, the network interfaces of each of the discovered nodes, the storage locations of each NAS asset, network interfaces configured for load balancing between other nodes in the node cluster, and network interfaces associated with each NAS asset.

Embodiments disclosed herein further include selecting, from the discovered nodes and/or network interfaces, the most appropriate interface for backups and recovery. When a NAS Array is added to backup application like a Dell PowerProtect Data Manager (PPDM) Server, it discovers complete details required for backup. When a backup runs on a schedule, an appropriate interface is used to run the backup to get desired throughput, resiliency and high availability of array nodes.

The method for processing the network interfaces of a new NAS system includes a user (e.g., an administrator of the NAS system) installing a NAS array (e.g., a NAS system) using a backup application, a plug-in in the NAS array installing NAS array Restful state transfer (REST) application programming interfaces (APIs) to perform discovery. The discovery includes discovering a cluster identifier (ID) to generate a unique entry with an elastic search database, all access zones or NAS servers of the array, cluster nodes configured with each access zone, and all management and data interfaces for each access zone. The management interfaces usually have a lower bandwidth (e.g. 1 gigabyte (GB) per second) pipe. In contrast, data interfaces usually have a bandwidth greater than or equal to 10 GB/s. A domain name system (DNS) resolvable network interface for the data path is named SmartConnect Fully Qualified Domain Name (FQDN). There could be multiple FQDNs for the same access zone. NAS assets configured with each access zone may each be associated with system access zones and/or non-system access zones. A non-system access zones may each be a sub-cluster of a NAS array cluster. The method may further include storing all discovered information in the elastic search database. The discovery runs automatically on a periodic basis. The periodic discovery updates any change in locality of the NAS shares, changes in network interfaces, and/or any changes in re-configurations.

After the components are discovered, a method for selecting the appropriate interface is performed. The method may include, for example, scheduling a backup policy for NAS assets in the NAS system, obtaining, for each NAS asset in the NAS system, a list of network interfaces associated with a control path between the NAS nodes storing the NAS asset and the backup agents performing the backup, and selecting, if any, NAS load distribution components (e.g., the SmartConnect FQDN) for a subset of network interfaces that are used to perform the backup. In instances in which no NAS load distribution components are available, the first network interface or preferred network interface configured with the NAS server is selected. The method further includes instantiating the backup on a backup agent. In this step, a list of all network interfaces are sent and the selected subset of network interfaces are specified. The backup agent may perform the backup in accordance with the specified subset of network interfaces.

Various embodiments of the invention are described below.

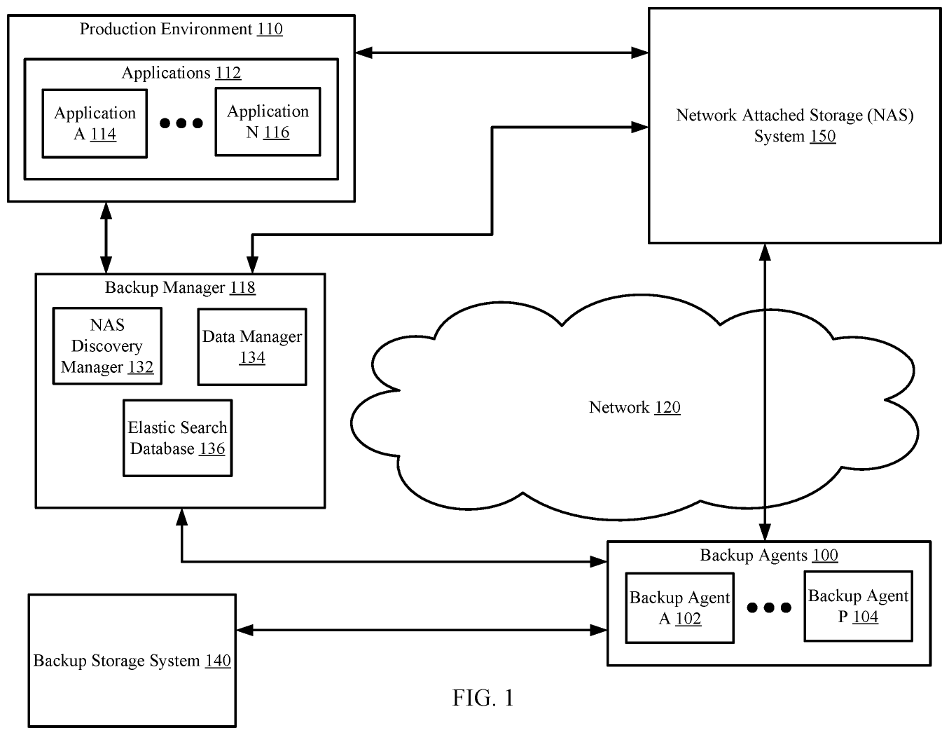

FIG. 1 shows an example system in accordance with one or more embodiments of the invention. The system includes a production environment (110) that includes one or more applications (112), a backup manager (118), a backup storage system (140), a set of backup agents (100), and a NAS system (150). The system may include additional, fewer, and/or different components without departing from the invention. Each component may be operably connected to any of the other components via any combination of wired and/or wireless connections. Each component illustrated in FIG. 1 is discussed below.

In one or more embodiments of the invention, the production environment (110) may include applications (112). These applications (112) may include one or more applications (114, 116). The applications (114, 116) may be logical entities executed using computing resources (not shown) of the production environment (110). Each of the applications (114, 116) may be performing similar or different processes. In one or more embodiments of the invention, the applications (112) provide services to users, e.g., clients (not shown). For example, the applications (112) may host components. The components may be, for example, instances of databases, email servers, and/or other components. The applications (112) may host other types of components without departing from the invention. An application (112) may be executed on one or more production hosts as instances of the application.

In one or more embodiments, the applications (112) may utilize a file system to manage the storage of data. In one or more embodiments of the invention, a file system is an organizational data structure that tracks how data is stored and retrieved in a system. The file system may specify references to files and any data blocks associated with each file. Each data block may include a portion of application data for an application. In one or more embodiments, the file data, application data, and/or other data utilized by the applications (112) are stored in the NAS system (150). The aforementioned data is accessed by the applications (112) via a NAS server (further discussed below) of the NAS system (150).

In one or more embodiments, the application data, file data, and/or other data may be grouped into NAS assets. In one or more embodiments, a NAS asset is a grouping of data blocks based on the organization of one or more file systems. For example, a NAS asset may include the data of all files in a file system. In another example, an NAS asset may include the data of multiple file systems. In another example, the NAS asset includes the data of one application (e.g., 114, 116). The data of the NAS assets may be stored in the NAS system (150).

In one or more of embodiments of the invention, the applications (112) are implemented as computer instructions, e.g., computer code, stored on a persistent storage that when executed by a processor(s) of a computing device cause the computing device to provide the functionality of the applications (112) described throughout this disclosure.

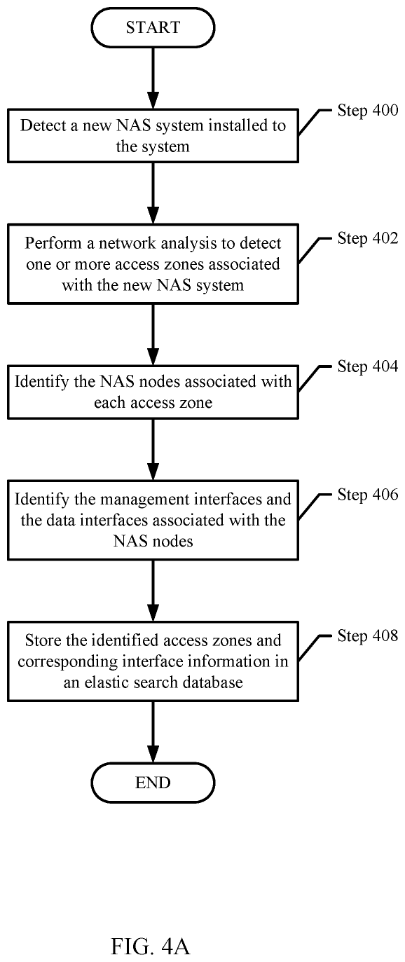

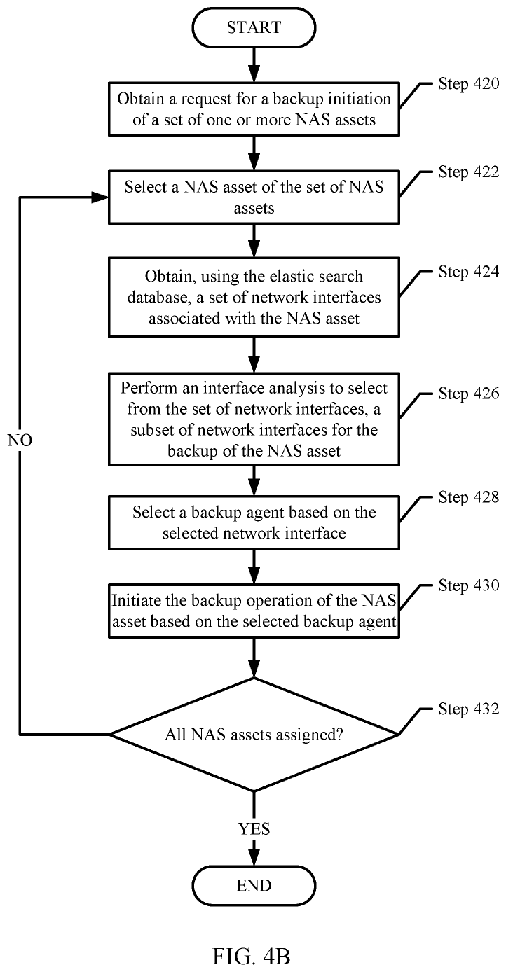

In one or more embodiments, the backup manager (118) includes functionality for servicing requests issued by the applications (112). The applications (112) may issue requests for performing workloads associated with the data accessed by the applications (112). The workloads may include workloads for backing up the application data, for accessing one or more files from the NAS system (150), for performing incremental backups of the application data, and/or any other workloads without departing from the invention. In one or more embodiments, the backup manager (118) services requests for workloads in accordance with FIGS. 4A-4B.

In one or more embodiments, the backup manager (118) includes a NAS discovery manager (132) that includes functionality for performing an interface analysis to discover communication channels via the network interfaces of the NAS system (150). The NAS discovery manager (132) may perform the interface analysis in accordance with, e.g., FIG. 4A. The interface analysis may be performed in accordance with other methods without departing from the invention.

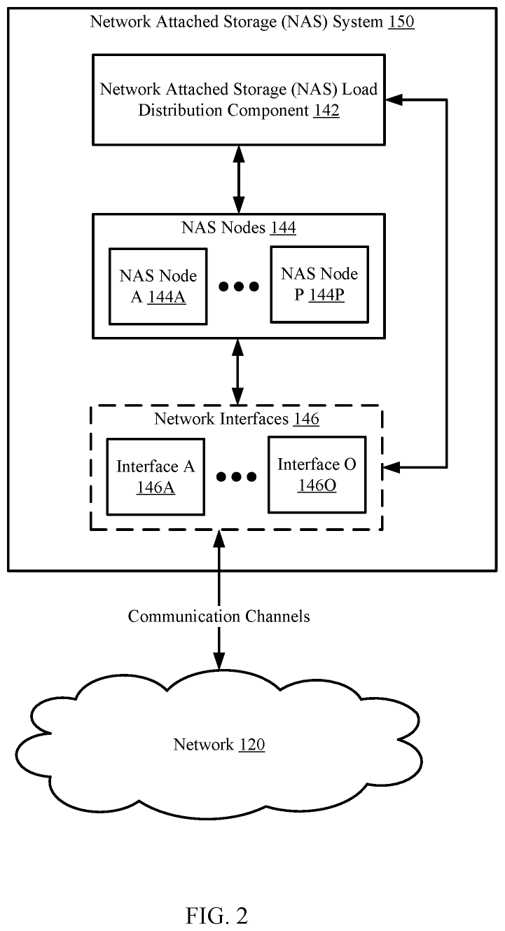

The discovered interfaces and/or communication channels may be stored in an elastic search database (136). In one or more embodiments, the elastic search database (136) is a data structure that stores the discovered network interfaces of the NAS system (150). The organization of the elastic search database (136) may enable an entity accessing it to identify the network interfaces on a per-NAS asset basis. For additional details regarding the network interfaces, see, e.g., FIG. 2.

In one or more embodiments, the backup manager (118) further includes a data manager (134) that includes functionality for managing the backup operations and/or the recovery operations of NAS assets. The data manager (134) may perform the method of FIG. 4B to determine at least a subset of network interfaces to be used to service backup requests for backing up one or more NAS assets. The backup manager (118) may initiate slice distribution using the backup agents (100) for generating backups to be stored in the backup storage system (140).

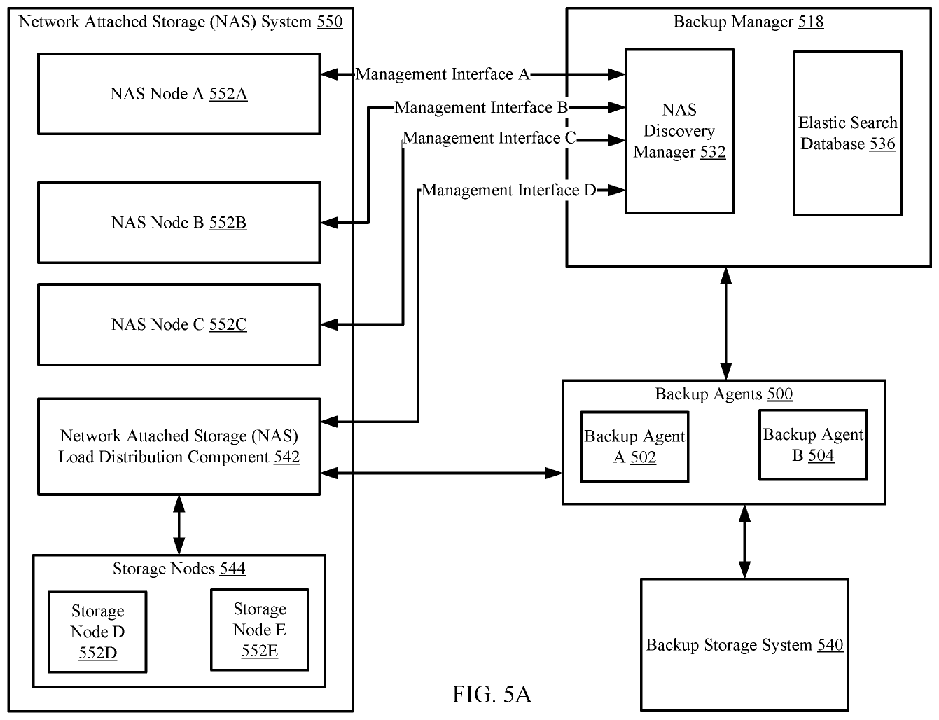

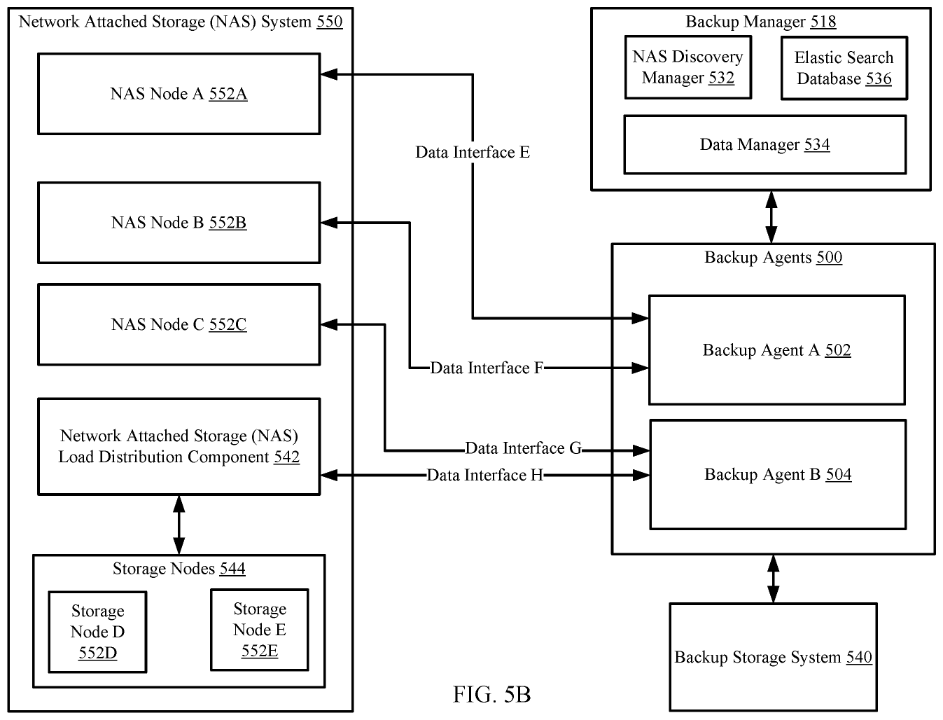

In one or more embodiments of the invention, the backup manager (118) is implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the backup manager (118) described throughout this disclosure and/or all, or a portion thereof, of the methods illustrated in FIGS. 4A-4B.

While not illustrated in FIG. 1, the production environment (110) may include multiple production hosts. Each production host may operate independently from each other. Each production host may include an operable connection to the NAS system (140) via one or more communication interfaces.

In one or more embodiments, the NAS system (150) includes functionality for servicing requests issued by the applications (112). The NAS system (150) may service the requests by accessing or otherwise obtaining data from NAS assets stored in NAS nodes (discussed below in FIG. 2) of the NAS system (150). The NAS system (150) may further include functionality for storing data provided from the applications (112).

In one or more embodiments, the NAS system (150) is implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the NAS system (150) described throughout this disclosure.

In one or more embodiments of the invention, the NAS system (150) is implemented as a logical device. The logical device may utilize the computing resources of any number of computing devices and thereby provide the functionality of the NAS system (150) described throughout this disclosure.

In one or more embodiments, the backup storage system (140) includes functionality for storing backups. The backups may be generated and/or stored via the backup manager (118). The backup storage system (140) may store backups obtained from the backup manager (118). The backups may be generated in accordance with FIGS. 4A-4B.

In one or more embodiments, the backup agents (100) include functionality for servicing backup tasks. The backup tasks may be pre-backup operations, backup operations, and post-backup operations. In one or more embodiments of the invention, the pre-backup operation is a process for generating a set of slices for one or more NAS assets. In one or more embodiments of the invention, the backup operation is a process for copying data associated with a NAS asset and transmitting the copy to the backup storage system (140) or to another backup agent for a post-backup operation. In one or more embodiments of the invention, the post-backup operation is a process for consolidating the data associated with the slices of a NAS asset to generate a backup of the NAS asset. The post-backup operation may further include transmitting the backup to the backup storage system (140). The backup operations may be performed in accordance with requests initiated by the backup manager (118).

In one or more embodiments of the invention, the backup agents (102, 104) each generate a backup container (not shown) to perform the backup tasks. Each backup container may be a virtualization of resources that includes functionality for obtaining data and servicing the corresponding backup task using an available stream (discussed below) of the backup agent (102, 104).

In one or more embodiments, the backup agents (102, 104) are each implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the backup agents (102, 104) described throughout this application.

In one or more embodiments of the invention, the backup agents (102, 104) are implemented as a logical device. The logical device may utilize the computing resources of any number of computing devices and thereby provide the functionality of the backup agents (102, 104) described throughout this application.

As discussed above, the NAS system includes functionality for servicing requests issued by applications. Turning to FIG. 2, FIG. 2 shows a diagram of a NAS system. The NAS system (150) includes a NAS load distribution component (142), one or more NAS nodes (144), and one or more network interfaces (146).

In one or more embodiments, the NAS load distribution component (142) includes functionality for distributing workloads among the NAS nodes (144). For example, the NAS load distribution component (144) obtains the service requests from the applications (e.g., via the network (120) and performs load balancing processes to determine the NAS node(s) (144A, 144P) to execute at least a portion of the service requests. The load balancing processes may base the determinations on, for example, (i) the workload of each NAS node (144A, 144P), (ii) the storage locations of data associated with the service requests, and (iii) the computing capabilities of the NAS nodes (144A, 144P).

In one or more embodiments, the NAS load distribution component (142) is each implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the NAS load distribution component (142) described throughout this application.

In one or more embodiments of the invention, the NAS load distribution component (142) is implemented as a logical device. The logical device may utilize the computing resources of any number of computing devices and thereby provide the functionality of the NAS load distribution component (142) described throughout this application.

In one or more embodiments of the invention, the NAS nodes (144) each include functionality for servicing service requests associated with NAS assets stored in the NAS nodes (144). The NAS nodes (144) may each store data associated with one or more NAS assets. The NAS nodes (144) may further write and read the data from the storage locations of the NAS assets in response to the service requests.

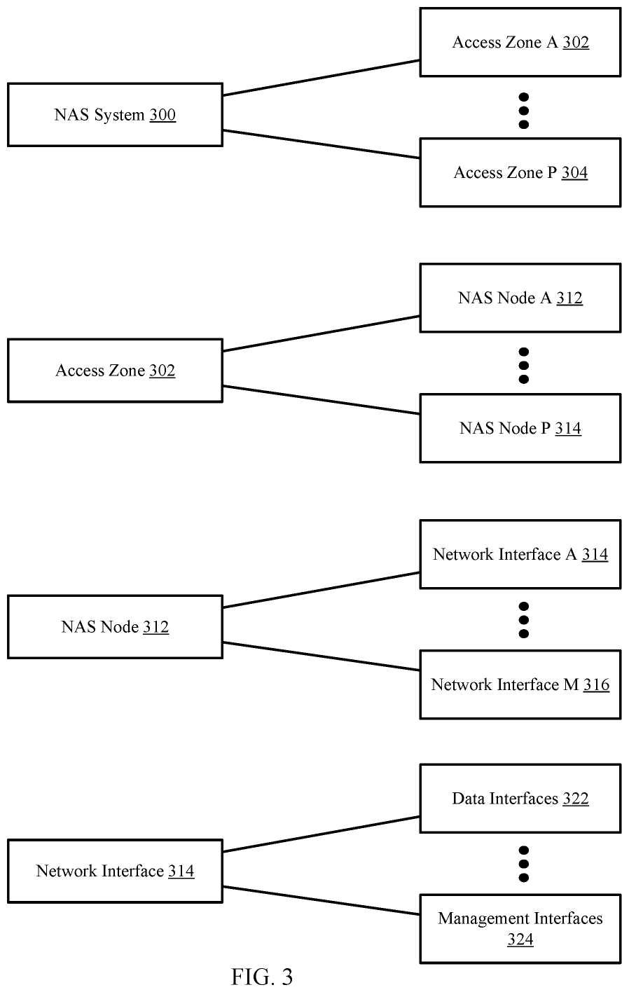

In one or more embodiments, the NAS nodes (144) may be grouped in accordance with access zones. In one or more embodiments, an access zone is a cluster of nodes that are grouped based on the corresponding network interface. For example, a cluster of NAS nodes may be accessed via a first access zone. A second example includes grouping a cluster of nodes on a second access zone based on a similarity of access of the network interfaces of the cluster of nodes. For additional details regarding the access zones, see, e.g., FIG. 3.

In one or more embodiments of the invention, the nodes may serve as management servers. A management server stores the data of a NAS asset (e.g., a file system) in a NAS node (144A, 144P) that serves as a storage node. The NAS system (144) may include any number of storage devices and management servers. Each storage device includes functionality for storing application data, file data (e.g., data associated with a file system), and/or any other data without departing from the invention. The data stored in the NAS system (150) may be accessible via one of the network interfaces (146).

In one or more embodiments, the NAS node (144A, 144P) are each implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the NAS node (144A, 144P) described throughout this application.

In one or more embodiments of the invention, the NAS node (144A, 144P) are implemented as a logical device. The logical device may utilize the computing resources of any number of computing devices and thereby provide the functionality of the NAS node (144A, 144P) described throughout this application.

In one or more embodiments, the network interfaces (146) include functionality for providing communication channels between components of the NAS system (150) (e.g., the NAS distribution component (142) and the NAS nodes (144)) and other components accessible via the network (120). The network interfaces (146) may be grouped based on the capability (e.g., bandwidth) of the network interfaces (146A, 146O). Specifically, the network interfaces (146) may be grouped into management interfaces and data interfaces. In one or more embodiments, the management interfaces may include functionality for providing a lower bandwidth than that of the data interfaces. As such, it may be preferable to transmit large amounts of data (e.g., for backup operations) to and from the NAS system (150) via a data interface. In contrast, it may be preferable to transmit lower sized data such as service requests via the management interfaces.

To clarify aspects of the invention, FIG. 3 shows relationship diagrams in accordance with one or more embodiments of the invention. The relationship diagrams illustrate the relationships between various components discussed throughout this disclosure.

As illustrated in FIG. 3, the NAS system (300) may include one or more access zones (302, 304). An access zone (302) may include one or more NAS nodes (312, 314). The grouping of the NAS nodes (312, 314) of the access zone (302) may be based on the network interfaces used by the NAS nodes (312, 314). As such, a NAS node (312) may include one or more network interfaces (314, 316). Each network interface (314, 316) may provide a connection to the NAS node (312) to another component in the system of FIG. 1. For example, a first network interface (314) may connect the NAS node (312) to a first backup agent (e.g. 102, FIG. 1), and a second network interface (316) may connect the NAS node (312) to a second backup agent (e.g., 104, FIG. 1). Each of the network interfaces (314) may include data interfaces (322) and management interfaces (324).

In one or more embodiments, the number of access zones (302, 304), an identifier of all NAS nodes of each access zone, and identifiers of each of the network interfaces of each NAS node are stored in the elastic search database (136, FIG. 1) discussed above. This information may be discovered in accordance with FIG. 4A.

FIGS. 4A-4B show flowcharts in accordance with one or more embodiments of the invention. While the various steps in the flowcharts are presented and described sequentially, one of ordinary skill in the relevant art will appreciate that some or all of the steps may be executed in different orders, may be combined or omitted, and some or all steps may be executed in parallel. In one embodiment of the invention, the steps shown in FIGS. 4A-4B may be performed in parallel with any other steps shown in FIGS. 4A-4B without departing from the scope of the invention.

FIG. 4A shows a flowchart for performing an interface discovery in accordance with one or more embodiments of the invention. The method shown in FIG. 4A may be performed by, for example, a backup manager (118, FIG. 1). Other components of the system illustrated in FIG. 1 may perform the method of FIG. 4A without departing from the invention.

Turning to FIG. 4A, in step 400, a new NAS system installed to the system is detected. In one or more embodiments, the NAS system is installed by an administrator of the NAS system.

In step 402, a network analysis is performed to detect one or more access zones associated with the new NAS system. In one or more embodiments, the access zones are detected by analyzing the network interfaces associated with each NAS node in the NAS system and grouping the NAS nodes based on the similarity of the communication channels provided by the network interfaces. In one or more embodiments, the access zones may be specified in a data structure of the NAS system that provides metadata associated with the access zones of the NAS system.

In step 404, the NAS nodes associated with each access zone are identified. In one or more embodiments, the NAS nodes are identified based on the connection via the network interfaces. A parsing of each network interface may be performed to determine the connected NAS nodes. The connected NAS nodes may be identified for each access zone.

In step 406, the management interfaces and data interfaces associated with the NAS nodes are identified. In one or more embodiments, the management interfaces are identified by performing a bandwidth measurement on the network interfaces to determine whether the network interfaces exceed a predetermined threshold. Each network interface that is below the threshold may be identified as a management interface; the network interfaces that meet or exceed the threshold may be identified as a data interface.

In another embodiment, the management interfaces are identified based on whether the network interface provides a communication channel to a management server. In one or more embodiments, a management server is a type of NAS node that includes capability for managing the operations of storage nodes in the NAS system. The storage nodes may be another type of NAS node that stores data associated with NAS assets. The network interfaces that provide a connection to the management servers may be identified as management interfaces.

In step 408, the identified access zones and corresponding interface information are stored in an elastic search database. In one or more embodiments, the corresponding interface information includes the identified management interfaces and the identified data interfaces. The interface information may further include the access zones and the corresponding NAS nodes of each access zone.

FIG. 4B shows a flowchart for selecting communication interfaces for a backup operation in accordance with one or more embodiments of the invention. The method shown in FIG. 4B may be performed by, for example, a backup manager (118, FIG. 1). Other components of the system illustrated in FIGS. 1-2 may perform the method of FIG. 4B without departing from the invention.

Turning to FIG. 4B, in step 420, a request for a backup initiation is obtained for a set of one or more NAS assets. In one or more embodiments, the request specifies the NAS asset(s) to be backed up.

In step 422, a NAS asset of the set of NAS assets is selected. In one or more embodiments, the selected NAS asset is one of the NAS assets specified in the request that has not been processed in accordance with steps 424-432.

In step 424, a set of network interfaces associated with the selected NAS asset is obtained. In one or more embodiments, the network interfaces are identified using the elastic search database, which specifies each NAS node, the stored NAS assets of each NAS node, and the corresponding network interfaces. The network interfaces associated with the NAS nodes storing the selected NAS asset are selected for the set of network interfaces.

In step 426, an interface analysis is performed to select, from the set of network interfaces, a subset of network interfaces for the backup of the NAS assets. In one or more embodiments, the interface analysis includes identifying the access zones associated with each of the network interface. The interface analysis further includes determining if whether a lower latency grouping of network interfaces are determined based on the access zones. For example, if the network interfaces required to access all of the data in the selected NAS asset are part of the same access zone, such network interfaces may be selected for the subset of network interfaces.

In one or more embodiments, the network interfaces are selected based on whether the network interfaces are data interfaces. The management interfaces may be removed from contention for the subset of network interfaces.

In one or more embodiments, the network interfaces are selected to the subset of network interfaces if the network interfaces provide a communication channel to a NAS load distribution component. Specifically, the NAS load distribution component may provide load balancing processes among a group of NAS nodes that store and/or manage the storage of the selected NAS asset. In this manner, the communication across the network to perform the backup operation is managed to a minimized number of network interfaces.

In step 428, a backup agent is selected based on the selected network interface. In one or more embodiments, the backup agent is selected based on the computing capability of the backup agent (including the available connection(s) between the selected backup agent and the subset of network interfaces). While step 428 describes the selection of one backup agent, two or more backup agents may be selected without departing from the invention.

In step 430, the backup operation is initiated using the selected backup agent. In one or more embodiments, the backup operation includes accessing the data associated with the selected NAS asset (via the subset of network interfaces), generating a copy of the data and transmitting the copy to the backup storage system. The backup operation may be performed using any method of data management without departing from the invention. For example, the backup operation may include the use of slice distribution among multiple backup agents and distributing the backup operation of slices of the NAS asset across multiple selected backup agents.

In step 432, a determination is made about whether all NAS assets are assigned. If all NAS assets are assigned, the method ends following step 432; otherwise, the method returns to step 422.

While the method of FIG. 4B describes a response to a request for a backup, embodiments of the invention may include similar methods for performing a recovery of NAS assets from the backup storage system. Such methods may include obtaining a set of network interfaces of each NAS asset to be recovered (similar to step 424), performing an interface analysis on each NAS asset (similar to step 426), selecting a backup agent for each NAS asset (similar to step 428), and performing a recovery operation to recover each NAS asset from the backup storage system to the NAS system via the corresponding network interfaces and the corresponding backup agents.

### EXAMPLE

The following section describes an example. The example, illustrated in FIG. 5, is not intended to limit the invention and is independent from any other examples discussed in this disclosure. Turning to the example, consider a scenario in which a NAS server utilizes a backup manager to obtain a backup of a NAS asset that includes a million files stored in a network attached storage (NAS) system.

Turning to the example, FIG. 5A shows a diagram of an example system. For the sake of brevity, not all components of the example system may be illustrated in FIG. 5A. The example system may include a backup manager (518), a backup storage system (540), a NAS system (550), and two backup agents (502, 504). The backup agents (502, 504) each include a set of backup containers. The NAS system (510) includes a NAS asset that is a file system that includes a million files.

The backup manager (518) includes a NAS discovery manager (532), an elastic search database (536), and a data manager (not shown in FIG. 5A). The NAS discovery manager (532) performs the method of FIG. 4A to discover the network interfaces associated with the new NAS system (550) to discover the management interfaces associated with each NAS node in the NAS system (550). Specifically, the backup manager discovers management interface A that connects the backup manager (518) to NAS node A (552A), management interface B that connects the backup manager (518) to NAS node B (552B), management interface C that connects the backup manager (518) to NAS node C (552C), and management interface D that connects the backup manager (518) to a NAS load distribution component (542). The network interfaces are determined to be management interfaces based on the maximum bandwidth of less than 1 gigabyte (GB).

Further, NAS nodes A, B and C (552A, 552B, 552C) are detected to be part of a first access zone, and storage nodes D and E (552D, 552E) are detected to be part of a second access zone and accessible via the NAS load distribution component (542). The NAS discovery manager (532) further detects a data interface between the NAS load distribution component and the backup agents (500). This data interfaces is detected to provide a maximum bandwidth of 30 GB. The detected management interfaces, access zones, and corresponding NAS nodes are tracked in an elastic search database (536) of the backup manager (518).

Turning to FIG. 5B, FIG. 5B shows a second diagram of the example system. For the sake of brevity, not all components of the example system may be illustrated in FIG. 5B. FIG. 5B illustrates additional network interfaces discovered by the NAS discovery manager (532). Specifically, FIG. 5B illustrates data interface E that connects backup agent A (502) to NAS node A (552A), data interface F that connects backup agent A (502) to NAS node B (552B), data interface G that connects backup agent B (504) to NAS node C (552C), and data interface H that connects backup agent B (504) to NAS load distribution component (542).

At a later point in time, a backup request is received for backing up a NAS asset to the backup storage system (540). A data manager (534) of the backup manager (518) performs the method of FIG. 5B to determine that the specified NAS asset is stored in NAS node C (552C) and the storage nodes (544). As such, the data manager (534) determines that the backup operation of the NAS asset is to be performed using data interface G and data interface H, which connect NAS node C (552C) and the NAS load distribution component (542) to backup agent B. As discussed above, the NAS load distribution component (542) performs a load balancing process on the storage nodes (544). In this manner, backup agent B is selected to perform the backup operation.

The data manager (534) initiates a backup operation by sending a storage request to backup agent B (504) to copy the data of the NAS asset and storing the backup in the backup storage system (540) using data interface G and data interface H. The backup agent, in response to the storage request, sends read requests to NAS node C (552C) for reading a copy of the data of the NAS asset stored in NAS node C (552C). The backup agent further sends read requests to the NAS load distribution component (542) for reading a copy of the data of the NAS asset stored in the storage nodes (544). The NAS load distribution component (542), in response to receiving the corresponding read requests, distributes the read requests across storage node D (552D) and storage node E (552E) of the storage nodes (544) to obtain the copy of the corresponding data. Backup agent B (504), after receiving the requested data, stores the copy in the backup storage system (540) as a backup of the NAS asset.

### End of Example

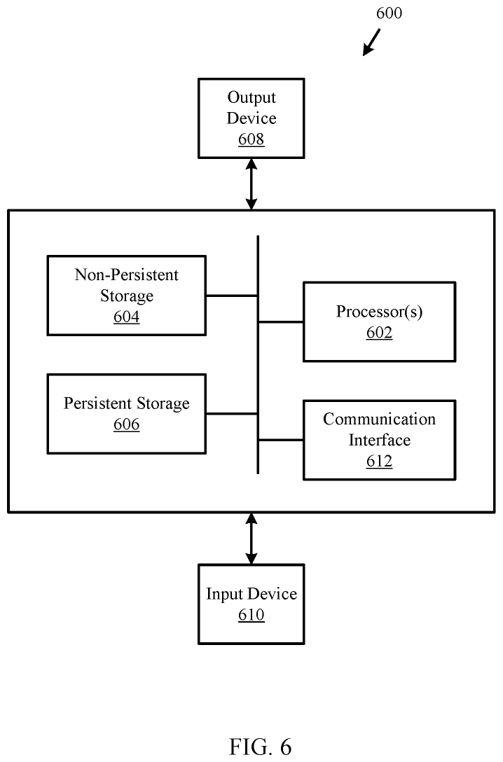

As discussed above, embodiments of the invention may be implemented using computing devices. FIG. 6 shows a diagram of a computing device in accordance with one or more embodiments of the invention. The computing device (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), input devices (610), output devices (608), and numerous other elements (not shown) and functionalities. Each of these components is described below.

In one embodiment of the invention, the computer processor(s) (602) may be an integrated circuit for processing instructions. For example, the computer processor(s) may be one or more cores or micro-cores of a processor. The computing device (600) may also include one or more input devices (610), such as a touchscreen, keyboard, mouse, microphone, touchpad, electronic pen, or any other type of input device. Further, the communication interface (612) may include an integrated circuit for connecting the computing device (600) to a network (not shown) (e.g., a local area network (LAN), a wide area network (WAN) such as the Internet, mobile network, or any other type of network) and/or to another device, such as another computing device.

In one embodiment of the invention, the computing device (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing devices exist, and the aforementioned input and output device(s) may take other forms.

One or more embodiments of the invention may be implemented using instructions executed by one or more processors of the backup manager. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A system comprising:
a network attached storage (NAS) system;
processor; and
a backup manager operating on the processor, programmed to:
obtain a backup request for a backup of a set of NAS assets;
in response to the backup request:
obtain, using an elastic search database, a list of network interfaces associated with a first NAS asset of the set of NAS assets and a second list of network interfaces associated with a second NAS asset of the set of NAS assets,
wherein the list of network interfaces and the second list of network interfaces is obtained based on a network interface discovery applied to the NAS system;
perform an interface analysis for the first NAS asset to select, from the list of network interfaces, a first subset of network interfaces; and
select a backup agent for a first backup operation based on the first subset of network interfaces; and
initiate the first backup operation based on the backup agent.

2. The system of claim 1, wherein the backup manager is further programmed to:
obtain a second list of network interfaces associated with a second NAS asset of the set of NAS assets;
perform a second interface analysis for the second NAS asset to select, from the second list of network interfaces, a second subset of network interfaces;
select a second backup agent for a second backup operation based on the second subset of network interfaces; and
initiate the second backup operation based on the second backup agent.

3. The system of claim 2, wherein the list of network interfaces is the same as the second list of network interfaces.

4. The system of claim 2, wherein the list of network interfaces and the second list of network interfaces are different.

5. The system of claim 2, wherein the second interface analysis comprises:
making a determination that the NAS system does not have a NAS load distribution component;
based on the determination, selecting a NAS node of the NAS system that stores the second NAS asset;
identifying, using the elastic search database, a data interface between the NAS node and the second backup agent; and
assigning the data interface to the second subset of network interfaces.

6. The system of claim 1, wherein the network interface discovery comprises:
detecting the NAS system in the system;
performing, after the detecting, a network analysis to detect a set of access zones associated with the NAS system;
identifying a set of management interfaces that connect a set of nodes in an access zone of the set of access zones to the backup manager;
identifying a set of data interfaces that connect the set of nodes in the access zone to the backup agent; and
storing, in the elastic search database, the set of access zones, the set of management interfaces and the set of data interfaces,
wherein the list of network interfaces comprise the set of management interfaces and the set of data interfaces.

7. The system of claim 6, wherein one of the set of data interfaces has a lower bandwidth than one of the set of management interfaces.

8. The system of claim 7, wherein the first subset of network interfaces only consists of the set of data interfaces.

9. The system of claim 1, wherein the interface analysis comprises:
detecting a data interface connected to a NAS load distribution component of the NAS system;
making a determination that the NAS load distribution component is capable of load distribution for a set of NAS nodes; and
based on the determination, selecting the data interface for the first subset of network interfaces.

10. The system of claim 1, wherein the backup agent is operatively connected to the NAS system and to a backup storage system.

11. The system of claim 10, wherein initiating the first backup operation comprises sending a backup operation request to the backup request for performing a backup operation of the set of NAS asset from the NAS system to the backup storage system.

12. A method for managing network attached storage (NAS) assets, the method comprising:
obtaining, by a backup manager and using an elastic search database, a list of network interfaces associated with a first NAS asset of a set of NAS assets and a second list of network interfaces associated with a second NAS asset of the set of NAS assets,
wherein the list of network interfaces and the second list of network interfaces is obtained based on a network interface discovery applied to a NAS system;
performing an interface analysis for the first NAS asset to select, from the list of network interfaces, a first subset of network interfaces; and
selecting a backup agent for a first backup operation based on the first subset of network interfaces; and
initiating the first backup operation based on the backup agent.

13. The method of claim 12, further comprising:
obtaining a second list of network interfaces associated with a second NAS asset of the set of NAS assets;
performing a second interface analysis for the second NAS asset to select, from the second list of network interfaces, a second subset of network interfaces;
selecting a second backup agent for a second backup operation based on the second subset of network interfaces; and
initiating the second backup operation based on the second backup agent.

14. The method of claim 13, wherein the list of network interfaces is the same as the second list of network interfaces.

15. The method of claim 13, wherein the list of network interfaces and the second list of network interfaces are different.

16. The method of claim 13, wherein the second interface analysis comprises:
making a determination that the NAS system does not have a NAS load distribution component;
based on the determination, selecting a NAS node of the NAS system that stores the second NAS asset;
identifying, using the elastic search database, a data interface between the NAS node and the second backup agent; and
assigning the data interface to the second subset of network interfaces.

17. The method of claim 12, wherein the network interface discovery comprises:
detecting the NAS system;
performing, after the detecting, a network analysis to detect a set of access zones associated with the NAS system;
identifying a set of management interfaces that connect a set of nodes in an access zone of the set of access zones to the backup manager;
identifying a set of data interfaces that connect the set of nodes in the access zone to the backup agent; and
storing, in the elastic search database, the set of access zones, the set of management interfaces and the set of data interfaces,
wherein the list of network interfaces comprise the set of management interfaces and the set of data interfaces.

18. The method of claim 17, wherein one of the set of data interfaces has a lower bandwidth than one of the set of management interfaces.

19. The method of claim 18, wherein the first subset of network interfaces only consists of the set of data interfaces.

20. A non-transitory computer readable medium comprising computer readable program code, which when executed by a computer processor enables the computer processor to perform a method for managing network attached storage (NAS) assets, the method comprising:
obtaining, by a backup manager and using an elastic search database, a list of network interfaces associated with a first NAS asset of the NAS assets and a second list of network interfaces associated with a second NAS asset of the NAS assets,
wherein the list of network interfaces and the second list of network interfaces is obtained based on a network interface discovery applied to a NAS system;
performing an interface analysis for the first NAS asset to select, from the list of network interfaces, a first subset of network interfaces; and
selecting a backup agent for a first backup operation based on the first subset of network interfaces; and
initiating the first backup operation based on the backup agent.
